(19) United States
(12) Patent Application Publication
(10) Pub. No.: US 2020/0034503 A1
(43) Pub. Date: Jan. 30, 2020

(54) Space Planning Options Management and Visualization System with Intelligent Dynamic Cascading

(71) Applicant: Effective Technology Solutions, Inc., Mountain View, CA (US)

(72) Inventor: Noam Livnat, Mountain View, CA (US)

(73) Assignee: Effective Technology Solutions, Inc.

(21) Appl. No.: 16/520,319

(22) Filed: Jul. 23, 2019

Related U.S. Application Data
(60) Provisional application No. 62/702,897, filed on Jul. 24, 2018.

(51) Int. Cl. G06F 17/50

(52) U.S. Cl. CPC G06F 17/5009; G06F 17/5004

(57) ABSTRACT

A space planning options management and visualization system provides an office space planner or a system operator a novel computer graphics-based future pathways simulation environment for potential future office floorplans. In one instance, a potential future office floorplan synthesized and simulated by the system includes employee relocation or reseating plans, office resource object allocation plans, office layout renovation plans, and departmental relocation plans. The space planning options management and visualization system is configured to synthesize, simulate, and visualize multiple instances of potential future office floorplans in one or more potential future pathways and various timeframes, which may develop timing co-dependencies and intricate parallel implications, even if one minor change is made to one particular plan at one particular time slice. The system provides a unique capability called “intelligent dynamic cascading” to autonomously and automatically modify floorplan(s) impacted by a change introduced to the particular plan, even without human intervention.

### BACKGROUND OF THE INVENTION

The present invention generally relates to space optimization systems and methods. More specifically, the present invention relates to computer-aided and computer graphics-enhanced space planning options creation, management, and visualization. The present invention also relates to autonomous machine-determined decisions in executing intelligent dynamic cascading in one or more potential future office floorplans, layouts, or space allocation scenarios.

A corporate office space serves as a primary work environment for many employees. The office space also incurs one of the largest expenses for a business entity outside of payroll expenditures. Because the office space-related expenses and the management of such spaces have a large impact on corporate finances as well as workers' experience and productivity, efficient management of the office space environment is critical to the success of the business entity.

The workplace, encompassing everything from the real estate housing the office to the amenities offered to employees, is a very dynamic environment, with its pace of change ever increasing in an ultra-competitive and globalized business environment. Companies and organizations need to constantly deal with these changes and seek continuous optimization of their costs and return on investment (ROI) in the workplace. Some of the key ongoing changes that have substantial impact on the workplace include, but are not limited to, property-related event deadlines (e.g. lease signing, expiration, other property-related key dates, etc.), employee-related dynamics as they join or leave a particular employer, and in-house movements of workers as they relocate or transfer within an organization, which can happen in the same physical location, or in different floors, buildings, states, or countries.

Furthermore, in some instances, growth or contraction of different business units (e.g. the marketing department of an organization may be expanding while the accounting department of the same organization may be shrinking) require readjustment or updates to workspace arrangements. In other instances, the configuration of the physical space may change due to a shift in corporate workplace culture or philosophy. For example, a company may want to transition from keeping most employees in private or semi-private offices to an open floorplan. In another example, multiple employees may share a combination of a number of spaces (e.g. hot-desking, hotel-desking, flex-seating, neighborhood seating in a particular workspace, etc.), instead of undergoing static one-to-one workspace assignments per employee.

Space planners and real estate teams play a key role in helping organizations that confront constant changes in the workplace. They are responsible for ensuring how an organization has appropriate real-estate assets by managing its real-estate portfolio. They are responsible for making sure offices and other real-estate assets are properly configured to satisfy the organization's needs and standards. For instance, a specific class of employees of a particular organization may each be expected to receive a workspace of a specific size and features according to the company policy (e.g. sit/stand desks for all, except for those with special ergonomic requirements, managers above a certain level get a private office of 165 sq. ft in size, etc.) Along with managers, space planners and real estate teams are also responsible for deciding which workspaces are allocated to which business units and teams, and the proximity of seating positions to the managers are typically planned ahead of actual physical arrangements. Desk assignments, flex-desking, hot-desking, hotel-desking, neighborhood seating, employee-workspace ratios, and other related workspace assignment parameters are also typically pre-configured and planned ahead of the actual physical relocation or arrangements.

In the process of workspace pre-configuration and personnel assignment planning, space planners and managers confront various and ever-changing complex issues, such as variable lease dates and costs, floor plan layouts, dynamically-changing employee rosters, and potential headcount changes or business unit reorganizations. It is difficult to anticipate all potential scenarios ahead of actual physical relocations or arrangements, and an effective optimization of workspace configuration and planning remains elusive using conventional and static floorplan visualization tools.

Furthermore, different space planning scenarios may focus workspace optimization emphasis on different metrics or criteria. In one scenario, an organization may value putting all members of a business unit or a team in close physical proximity to each other (e.g. all of Marketing in floors 2 and 3, Sales in 4 and 5, and Engineering in floor 13). In another scenario, it may prefer to organize project or product teams in close proximity (e.g. consumer products in floors 2 and 3, business products in floor 4 and 5). Yet in another scenario, it may value minimizing the cost of real estate (e.g. consolidate from three buildings to two to reduce lease expenses). Alternatively, the organization may place emphasis on minimizing employee relocation-related disruptions (e g minimizing employee relocations whenever possible while accommodating growth in various departments).

Furthermore, an additional complexity in workspace planning and arrangement is experienced if an organization is exploring changes that may occur in multiple stages over time. For example, “Stage 1” may involve moving 200 employees from second and third floors in “Building A” to a temporary location in “Building B.” “Stage 2” may involve moving 200 employees from twelfth and thirteenth floors in Building A into the recently-vacated second and third floors in Building A. Moreover, “Stage 3” may involve moving 200 employees (i.e. originally from the second and the third floors in Building A) from their currently-utilized temporary perch in Building B to the twelfth and the thirteenth floors in Building A. These relocations may take place at various times, and thus need to be planned for and managed individually. In many situations, there are sequential timing co-dependencies and space arrangement complexities arising from such multi-stage workspace planning scenarios. As a case in point, in the example above, the employees originally seated in the second and the third floors in Building A cannot move to the twelfth and the thirteenth floors of the same building until the previous occupants of those floors are relocated to the second and the third floors.

In conventional methods of office space planning, exploring various scenarios for workspace optimizations typically involve modifying printed floor plans or using a computer program such as “Computer Aided Facility Management” (CAFM) tools. Utilizing printed floor plans enable a planner to provide visual representation of various scenarios, and such printed floor plans can be readily shared and discussed in a group meeting. On the other hand, by utilizing a CAFM program, such as the ones offered by IBM Tririga, FM:Systems, or SerraView, space planners and/or managers can typically enjoy the benefits of electronic record keeping, statistics, and reporting. However, existing CAFM programs merely provide limited electronic recordkeeping capabilities and do not accommodate various and complex needs associated with workspace planning scenario creations, visualizations, and modifications.

At best, a typical planning process in a conventional CAFM program involves generating a “move list,” which indicates who needs to move from current seats to new seat positions. The move list is typically generated by matching an employee name with a new seat number either by typing relevant information, or by visually indicating a new desired location for the employee via a “drag-and-drop” graphical interface. However, in all cases, the existing CAFM program's starting point is an employee current location, and the move list is stored and displayed as “static” lists of moves. The existing conventional CAFM programs are unable to support multiple space planning options scenarios, multiple hypothetical pathways for future workspace change scenario visualizations, and/or time co-dependency variabilities in relocation parameters (e.g. seat numbers, occupied office locations, ever-changing number of employees in various departments, corporate workspace utilization philosophy changes, etc.), which may be real-time and non-static variables in sequential instances of a particular space planning options scenario.

Therefore, it may be desirable to devise a novel electronic system capable of providing space planning options management and visualization that accommodate multiple space planning options scenarios, multiple hypothetical pathways for future workspace change scenario visualizations, and/or time co-dependency variabilities in relocation parameters. It may also be desirable to incorporate novel dynamic cascading capabilities into the novel electronic system to autonomously resolve or optimize time co-dependency variabilities in relocation parameters, even without manual human operator interventions.

Furthermore, it may also be desirable to provide a novel electronic system capable of conducting parallel implications analysis on various potential future office floorplans and reporting dynamically-changing parameters during or after the intelligent dynamic cascading.

In addition, it may also be desirable to provide a method of operating a space planning options management and visualization system that accommodates multiple space planning options scenarios, multiple hypothetical pathways for future workspace change scenario visualizations, and/or time co-dependency variabilities in relocation parameters.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a method for operating a space planning options management and visualization system with intelligent dynamic cascading for efficient office space planning simulations is disclosed. This method comprises the steps of: (1) generating a current-state office floorplan as a first set of computer-rendered graphics from a space planning optionality synthesis and visualization module connected to a CPU and a memory unit in the space planning options management and visualization system, wherein the current-state office floorplan includes at least one of employee seating assignments and office resource object allocation configurations; (2) generating a first potential future office floorplan as a second set of computer-rendered graphics from the space planning optionality synthesis and visualization module connected to the CPU and the memory unit in the space planning options management and visualization system, wherein the first potential future office floorplan incorporates a first modification in the employee seating assignments or in the office resource object allocations relative to the current-state office floorplan; (3) generating a second potential future office floorplan as a third set of computer-rendered graphics from the space planning optionality synthesis and visualization module connected to the CPU and the memory unit in the space planning options management and visualization system, wherein the second potential future office floorplan incorporates a second modification in the employee seating assignments or in the office resource object allocations relative to at least one of the current-state office floorplan and the first potential future office floorplan; (4) executing a third modification to either the first potential future office floorplan or the second potential future office floorplan as a fourth set of computer-rendered graphics from the space planning optionality synthesis and visualization module connected to the CPU and the memory unit in the space planning options management and visualization system, wherein the first potential future office floorplan and the second potential future office floorplan are part of same time-sequential instances originating from the current-state office floorplan; and (5) if the third modification triggers an intelligent dynamic cascading process due to timing co-dependencies between the first potential future office floorplan and the second potential future office floorplan: executing the intelligent dynamic cascading process from a machine-determined intelligent dynamic cascading module connected to the CPU and the memory unit in the space planning options management and visualization system, which in turn activates autonomous machine-determined decisions to automatically modify, without a human operator intervention, at least one of the employee seating assignments and the office resource object allocations to keep both the first potential office floorplan and the second potential future office floorplan logically consistent across different timeframes; and graphically rendering a newly-updated potential future office floorplan that incorporated machine-determined modifications to the employee seating assignments or to the office resource object allocations after executing the intelligent dynamic cascading process.

### BRIEF DESCRIPTION OF DRAWINGS

FIG. 1 shows an initial state of an office floorplan generated by a space planning options management and visualization system with intelligent dynamic cascading, in accordance with an embodiment of the invention.

FIG. 2 shows an example of a creation of a first potential future office floorplan (i.e. the “June 21” plan) generated by the space planning options management and visualization system with intelligent dynamic cascading, in accordance with an embodiment of the invention.

FIG. 3A shows an example of updates to the first potential future office floorplan generated by the space planning options management and visualization system with intelligent dynamic cascading, in accordance with an embodiment of the invention.

FIG. 3B shows a current-state (i.e. “Now”) screenshot of the office floorplan after the first potential future office floorplan updates are made by the space planning options management and visualization system with intelligent dynamic cascading, in accordance with an embodiment of the invention.

FIG. 4 shows an example of a creation of a second potential future office floorplan (i.e. the “July 20” plan) by the space planning options management and visualization system with intelligent dynamic cascading, in accordance with an embodiment of the invention.

FIG. 5 shows changes made to the second potential future office floorplan (i.e. the “July 20” plan) by the space planning options management and visualization system with intelligent dynamic cascading, in accordance with an embodiment of the invention.

FIG. 6A shows a screenshot of the first potential future office floorplan (i.e. the “June 21” plan) after additional amendments are incorporated by the space planning options management and visualization system with intelligent dynamic cascading, in accordance with an embodiment of the invention.

FIG. 6B shows a screenshot of intelligent dynamic cascading executing intelligent and autonomously machine-determined changes to a later-date floorplan (e.g. the “July 20” plan) after detecting amendments in an earlier-date floorplan (e.g. the “June 21” plan by the space planning options management and visualization system with intelligent dynamic cascading, in accordance with an embodiment of the invention.

FIG. 7 shows an operational flowchart for the space planning options management and visualization system with intelligent dynamic cascading, in accordance with an embodiment of the invention.

FIG. 8 shows a hardware system block diagram for the space planning options management and visualization system with intelligent dynamic cascading, in accordance with an embodiment of the invention.

FIG. 9 shows a space planning optionality synthesis and visualization module, in accordance with an embodiment of the invention.

FIG. 10 shows a machine-determined intelligent dynamic cascading module, in accordance with an embodiment of the invention.

FIG. 11 shows an example of parallel implications and timing co-dependency taken account into the machine-determined intelligent dynamic cascading in various office floorplans, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of descriptions of shapes, configurations, and/or other symbolic representations that directly or indirectly resemble one or more space planning options management and visualization systems with intelligent dynamic cascading and methods of operating such systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term herein referred to as “floorplan” or “plan” is defined as one or more computer graphics-generated hypothetical office space arrangement, employee relocation, seat assignment, and/or modification scenarios, which may or may not be implemented in real life. Multiple floorplans can be sequentially associated as sequential future instances originating from one “initial state” floorplan that serves as a real-life or hypothetically-simulated origin for future changes made to the initial state floorplan. Multiple “initial state” floorplans that create multiple and separate sequential future instances for each initial state floorplan are also supported by various embodiments of the present invention. Furthermore, multiple derivative floorplans branching out from a sequential future instance of an initial state floorplan are also provided by various embodiments of the present invention.

Moreover, for the purpose of describing the invention, a term herein referred to as “potential future office floorplan” is defined as one particular instance of a time-sequenced and hypothetically-implementable future plan, which is derived from an initial state floorplan or another earlier-date floorplan.

In addition, for the purpose of describing the invention, a term herein referred to as “space,” “workspace,” or “office space,” is defined as business, retail, manufacturing, corporate, and/or academic premises that may be utilized by one or more group of people. For example, a “space” may be an office floor, a conference room, a private office, a cubicle area, an auditorium, or a lunch room in a corporate building.

Moreover, for the purpose of describing the invention, a term herein referred to as “intelligent dynamic cascading” is defined as one or more autonomous machine-determined decisions for modifying one or more employee seating assignments and/or other office floorplan parameters, based on the machine's automated detection and proactive interpretation of a human operator-driven modification in one particular office floorplan that may have caused office space design parameter timing co-dependencies in other potential future office floorplans of one or more potential future pathways, which are also synthesized by the space options planning management and visualization system. Preferably, the intelligent dynamic cascading autonomously determined by the machine may also improve the overall employee relocation efficiency and associated costs (e g minimizing the number of unnecessary multiple employee relocations, costs associated with relocations, space footprint(s) of a particular organization, furniture or other equipment purchase needs, etc.) by autonomously modifying one or more employee seating assignments and/or other office floorplan parameters in other potential future office floorplans of one or more potential future pathways, when the human operator-driven modification is made in one particular office floorplan.

Furthermore, for the purpose of describing the invention, a term herein referred to as a “module” is defined as a specialized logical component comprising one or more software and/or chip-encoded hardware logical units that perform special-purpose task(s) and function(s) to enable specialized functionalities in a space planning options management and visualization system.

One aspect of an embodiment of the present invention is providing a novel space planning options management and visualization system that accommodates multiple space planning options scenarios, multiple hypothetical pathways for future workspace change scenario visualizations, and/or time co-dependency variabilities in relocation parameters.

Another aspect of an embodiment of the present invention is providing a novel space planning options management and visualization system configured to perform intelligent dynamic cascading, which resolves or optimizes time co-dependency variabilities in relocation parameters via autonomous machine-determined decisions, even without manual human operator interventions.

Furthermore, another aspect of an embodiment of the present invention is providing a novel electronic system capable of conducting parallel implications analysis on various potential future office floorplans and reporting dynamically-changing parameters during or after the intelligent dynamic cascading.

Yet another aspect of an embodiment of the present invention is providing a method of operating a space planning options management and visualization system that accommodates multiple space planning options scenarios, multiple hypothetical pathways for future workspace change scenario visualizations, and/or time co-dependency variabilities in relocation parameters.

Various embodiments of the present invention address the complexity of multi-stage change and scenario planning by providing a novel, time-sequence-based visualization interface to develop, explore and analyze, and execute mutually-dependable change scenarios using a computer program and user interface.

For the operation of the space planning options management and visualization system with intelligent dynamic cascading, the current state of affairs of an organization's real estate and seating configuration is considered the current baseline, hereinafter referred to as “NOW.” An option to effect any change in this configuration at a future date or timeframe is hereinafter referred to as a “plan,” “floorplan,” or “office floorplan.” The starting state of each plan is the putative completion of the plan whose date precedes it most closely. If no such plan exists, then the starting point of a plan is the NOW state.

In a preferred embodiment of the invention, each plan is associated with a date (i.e. the putative date in which the plan would be in effect), or with a sequence of events. Each plan may further be associated with additional information such as a name (e.g. “Engineering move”) or any other related parameters (e.g. the number of moves associated with it, an assessment of the disruption level it may cause, its cost, etc.). Furthermore, each plan may contain zero or more changes to its starting state, indicating the “end state” of the organization's workplace configuration per plan, if the plan were to be physically implemented by the organization beyond computer graphical simulations.

In one embodiment of the invention, an office space plan may include various information associated with an office space configuration, such as a geometrical layout of the office space, sectional or location labels associated with the office space, employee/worker seating arrangements, and resource object allocations. In one example, the office space plan may include the following information:

(1) Seats numbered 1002-1010 on the first floor of building A would be allocated to the Marketing Department (having previously belonged to the Sales department or to no business unit at all);
(2) New seating location of certain employees (e.g. “Art Asimov” will be now seated in Seat 2001 on the second floor of Building B, while “Beth Brooks” will be seated next to “Art Asimov” in Seat 2002);
(3) Certain employees will no longer be seated (e.g. “Cindy Cook” and “Dave Dunkirk” will no longer have an assigned seat);
(4) Certain properties or designations of workspaces will change (e.g. a private office will be turned into a meeting room, some designated workspaces will now be converted to hot desks, hotel desks, neighborhood desks, or flex desks, a cubicle will be reconfigured as a bench desk, access restrictions to such converted areas are specified in the office space plan, etc.);
(5) New workspaces will be added to certain floors in the office space plan;
(6) Certain workspaces will be removed from certain floors in the office space plan;
(7) Part of the layout of a certain floor will be altered in the office space plan;
(8) Certain floors or buildings will not be available for the organization's space occupancy in the office space plan; and
(9) New floors or buildings will be available for the organization's space occupancy in the office space plan.

For the space planning options management and visualization system disclosed in various embodiments of the present invention, multiple instances of plans or scenarios may exist for the same date/same timeframe, as system operators explore different configuration and usage alternatives. For example, the Marketing and Sales Departments may be allocated Floor 2 and Floor 3 of Building A, respectively, under “Plan A” for Jul. 1, 2021, while under “Plan B” for the same date, these floors would be occupied by the Engineering Department, with Sales and Marketing Departments sharing Floor 7 of Building B instead. One or more of these parallel scenarios for each plan, hereinafter referred to as “potential future pathways,” or “potential future office floorplans,” may exist for any given date, and changes to one instance of a plan in one particular future date does not affect other instances of the plan on the same particular future date, as each instance represents a unique future pathway for that particular future date in office space planning scenarios. Furthermore, various embodiments of the present invention can also accommodate creation of a new plan as a “duplicated” plan for a given date based on an existing plan for the same date, which allows for further exploration of variations on a given plan/scenario.

Although parallel instances of office space plans for the same date are independent of each other to enable computerized simulation of various space planning scenarios for that same date, such plans may have a cascading time co-dependency according to their time sequence. For example, the baseline state of Jul. 20, 2020 is the end-state of the plan for Jun. 21, 2020. Thus, changes to the “June 21^{st}” plan creates time co-dependencies to a corresponding plan on a previous date (e.g. the June 20th plan), which may require parallel implication analysis to keep various office space planning parameters logically coherent and consistent with the new changes made to the June 21^{st} plan. Therefore, machine-based autonomous identifications of “cascaded” plan modification needs and electronic modifications to all pertinent instances of the office space plan in various dates and timeframes are both advantageous and novel aspects of various embodiments of the present invention.

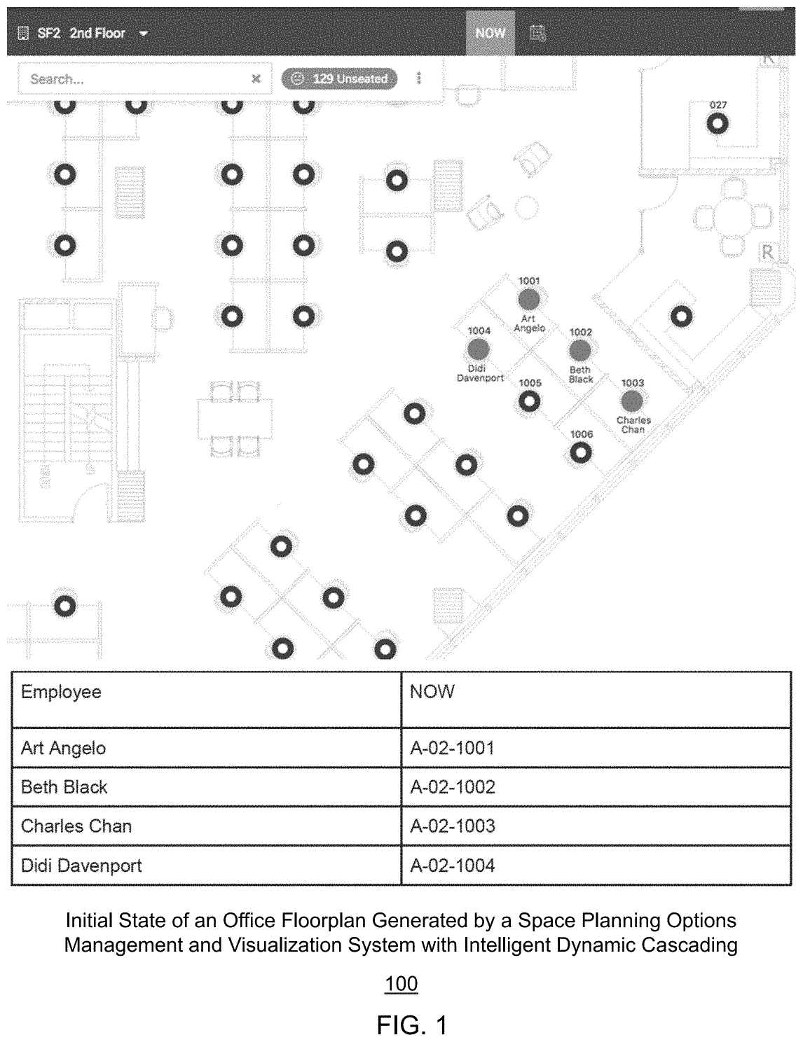

FIG. 1 shows an initial state (100) of an office floorplan generated by a space planning options management and visualization system with intelligent dynamic cascading, in accordance with an embodiment of the invention. The initial state (100) may also include information as indicated in the following table:

1 Initial state:

| Employee | NOW |
|---|---|
| Art Angelo | A-02-1001 |
| Beth Black | A-02-1002 |
| Charles Chan | A-02-1003 |
| Didi Davenport | A-02-1004 |

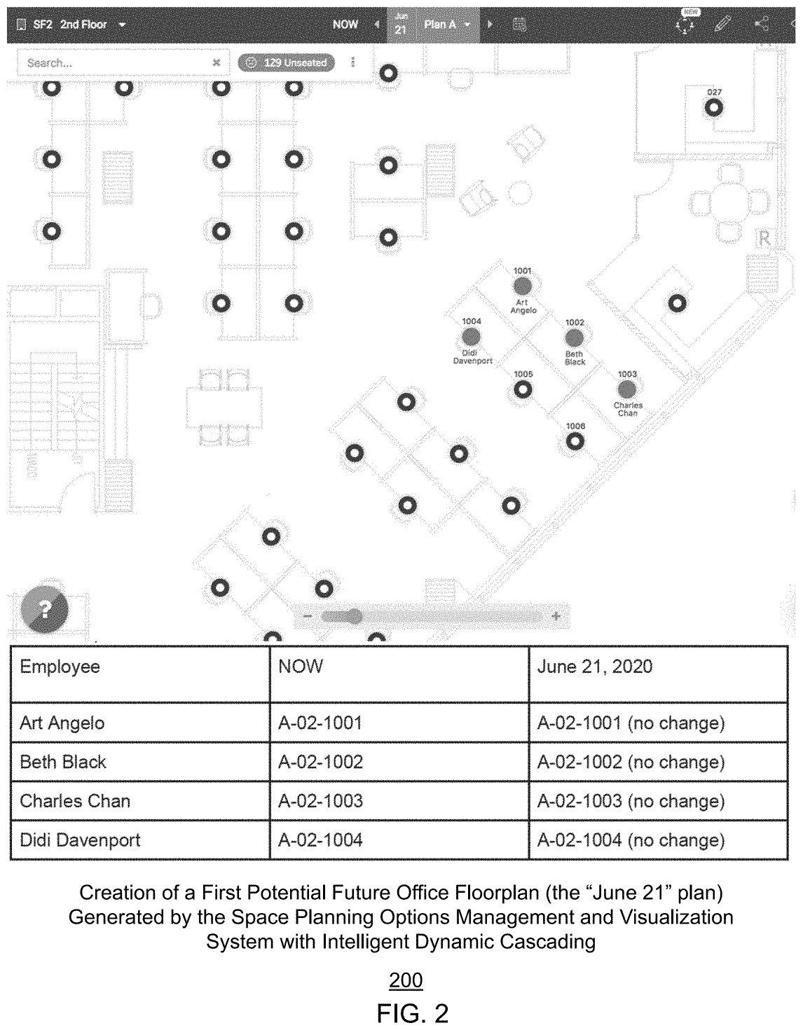

FIG. 2 shows an example (200) of a creation of a first potential future office floorplan (i.e. the “June 21” plan) generated by the space planning options management and visualization system with intelligent dynamic cascading, in accordance with an embodiment of the invention. This example (200) may also include information as indicated in the following table:

2 When a plan for Jun. 21, 2020 is created:

| Employee | NOW | Jun. 21, 2020 |
|---|---|---|
| Art Angelo | A-02-1001 | A-02-1001 |
| | | (no change) |
| Beth Black | A-02-1002 | A-02-1002 |
| | | (no change) |
| Charles Chan | A-02-1003 | A-02-1003 |
| | | (no change) |
| Didi Davenport | A-02-1004 | A-02-1004 |
| | | (no change) |

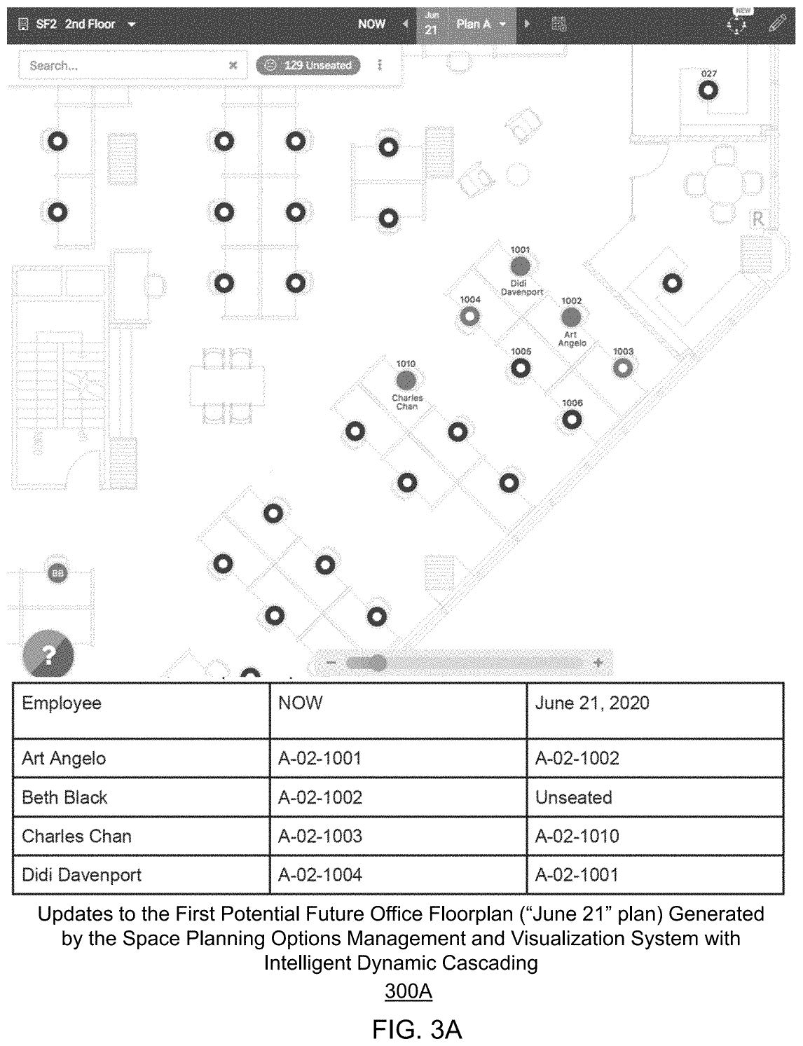

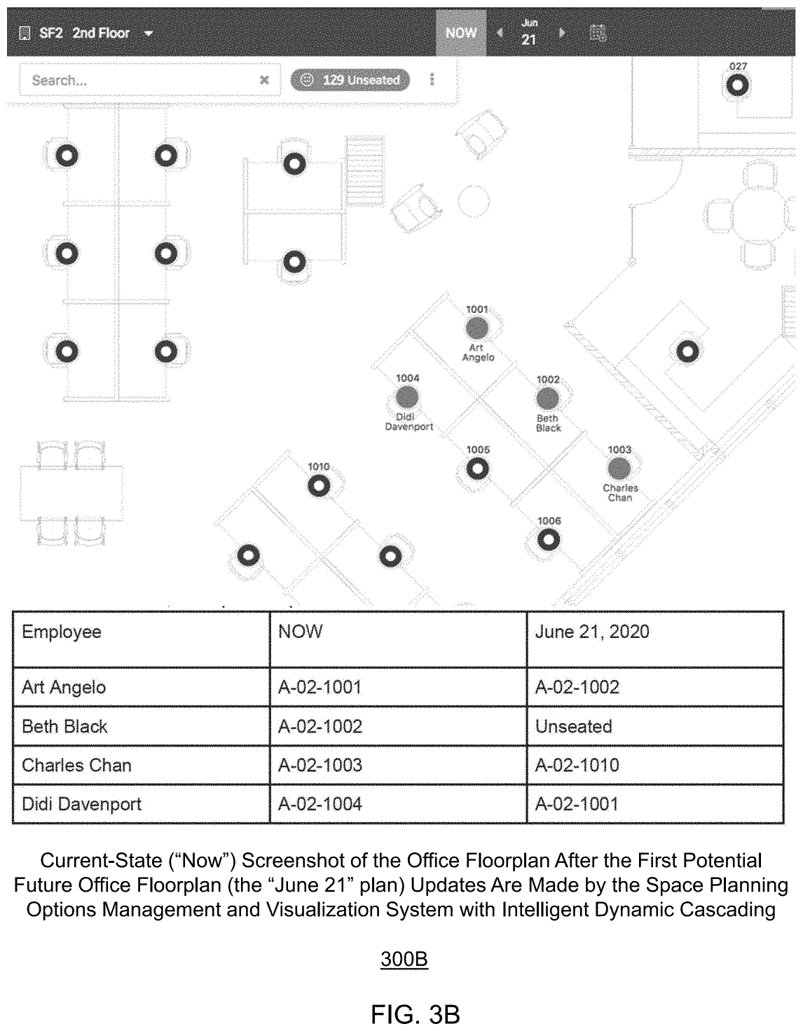

FIG. 3A shows an example (300A) of updates to the first potential future office floorplan generated by the space planning options management and visualization system with intelligent dynamic cascading, in accordance with an embodiment of the invention. The screenshot shown in this example (300A) graphically represents a future-date plan diagram (i.e. the “June 21^{st}” plan, with the instance of the plan being “Plan A”), as illustrated by an upper user interface highlight in FIG. 3A.

Furthermore, FIG. 3B shows a current-state (i.e. “Now”) screenshot (300B) of the office floorplan after the first potential future office floorplan updates are made by the space planning options management and visualization system with intelligent dynamic cascading, in accordance with an embodiment of the invention. The screenshot shown in this example (300B) graphically represents a NOW-state, as opposed to the future-date state (i.e. the “June 21^{st}” plan) previously illustrated in FIG. 3A. The visually-highlighted “NOW” in the upper user interface shown in this example indicates that the office space plan diagram generated by the system is visually depicting the NOW-state in FIG. 3B, unlike the future-date state diagram shown in FIG. 3A.

Furthermore, these examples (300A, 300B) may also include updated future-date state information as indicated in the following table:

3 after the Jun. 21, 2020 Plan is Updated:

| Employee | NOW | Jun. 21, 2020 |
|---|---|---|
| Art Angelo | A-02-1001 | A-02-1002 |
| Beth Black | A-02-1002 | Unseated |
| Charles Chan | A-02-1003 | A-02-1010 |
| Didi Davenport | A-02-1004 | A-02-1001 |

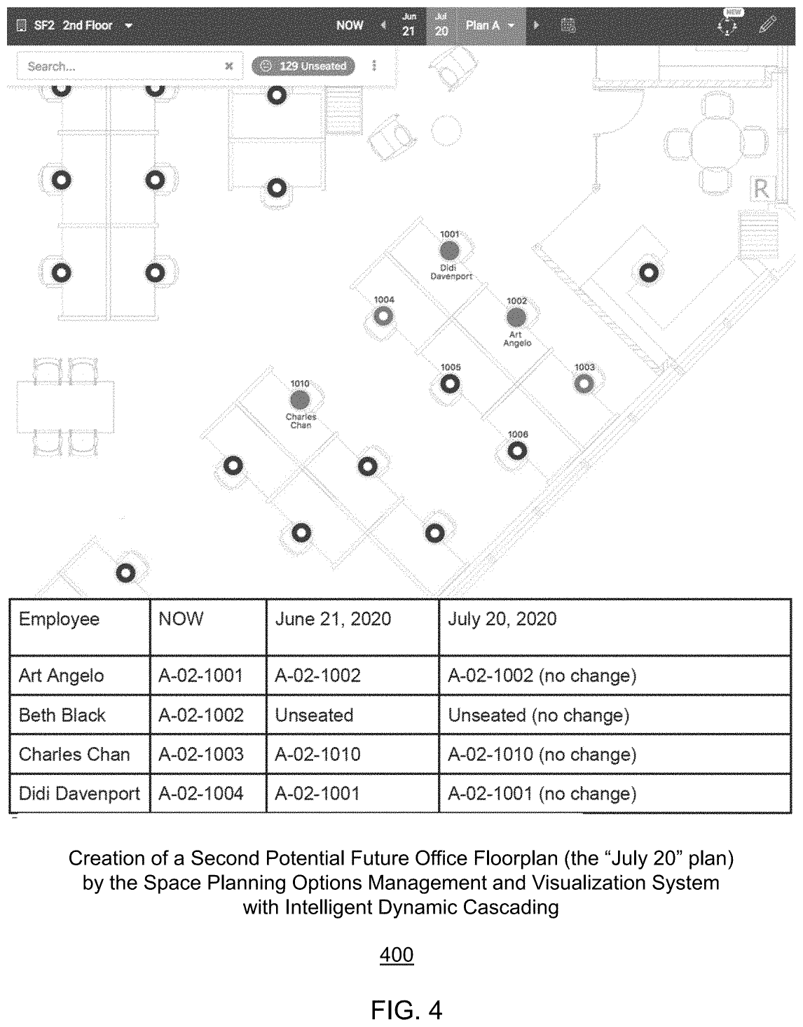

FIG. 4 shows an example (400) of a creation of a second potential future office floorplan (i.e. the “July 20” plan) by the space planning options management and visualization system with intelligent dynamic cascading, in accordance with an embodiment of the invention. This example (400) may also include updated information as indicated in the following table:

4 after Creating a Plan for Jul. 20, 2020

| Employee | NOW | Jun. 21, 2020 | Jul. 20, 2020 |
|---|---|---|---|
| Art Angelo | A-02-1001 | A-02-1002 | A-02-1002 |
| | | | (no change) |
| Beth Black | A-02-1002 | Unseated | Unseated |
| | | | (no change) |
| Charles Chan | A-02-1003 | A-02-1010 | A-02-1010 |
| | | | (no change) |
| Didi | A-02-1004 | A-02-1001 | A-02-1001 |
| Davenport | | | (no change) |

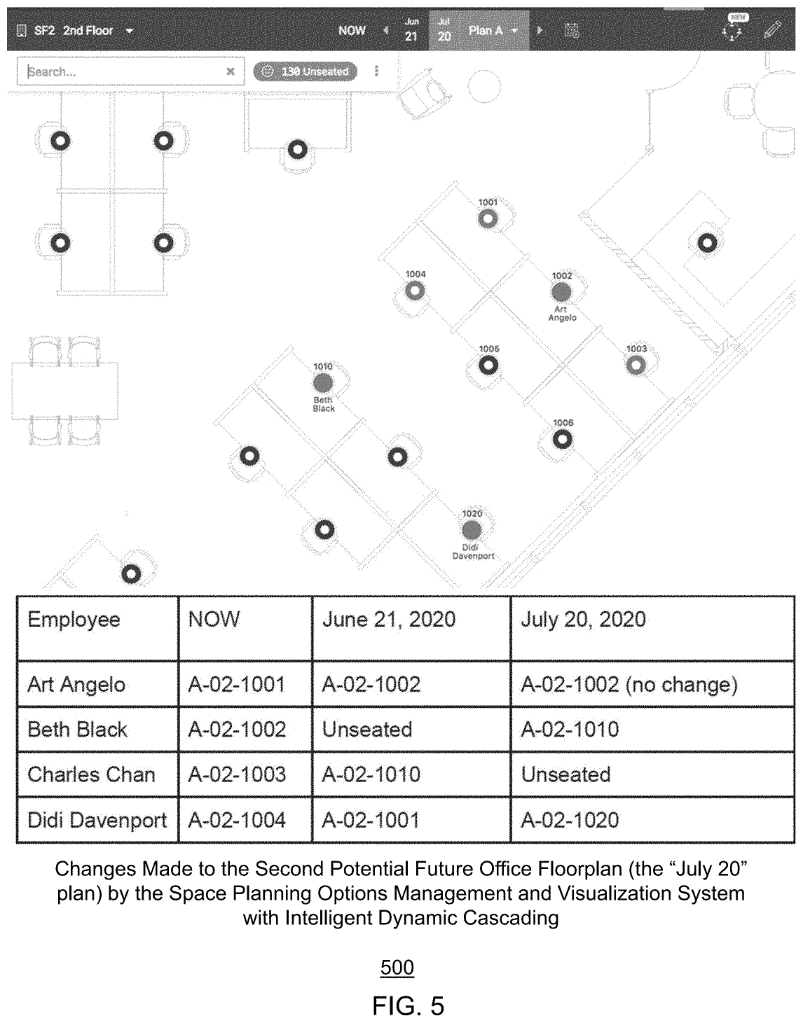

FIG. 5 shows an example (500) of changes made to the second potential future office floorplan (i.e. the “July 20” plan) by the space planning options management and visualization system with intelligent dynamic cascading, in accordance with an embodiment of the invention. This example (500) may also include updated information as indicated in the following table:

5 after Updating the Jul. 20, 2020 Plan

| Employee | NOW | Jun. 21, 2020 | Jul. 20, 2020 |
|---|---|---|---|
| Art Angelo | A-02-1001 | A-02-1002 | A-02-1002 |
| | | | (no change) |
| Beth Black | A-02-1002 | Unseated | A-02-1010 |
| Charles Chan | A-02-1003 | A-02-1010 | Unseated |
| Didi | A-02-1004 | A-02-1001 | A-02-1020 |
| Davenport | | | |

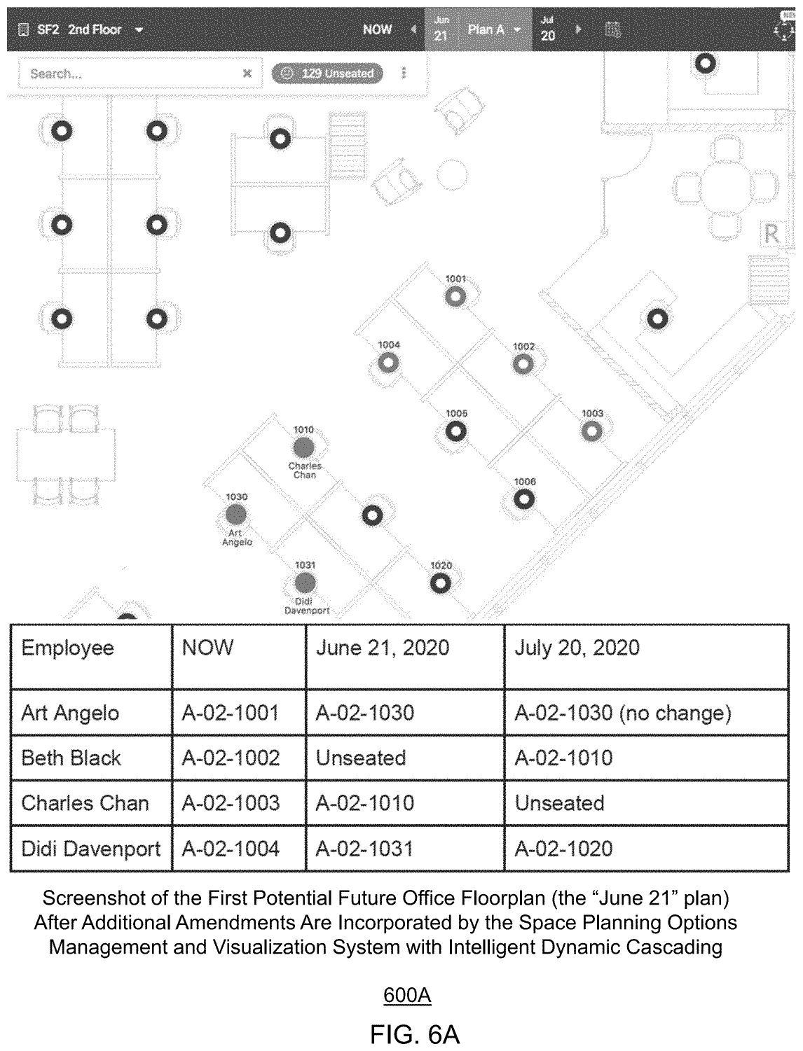

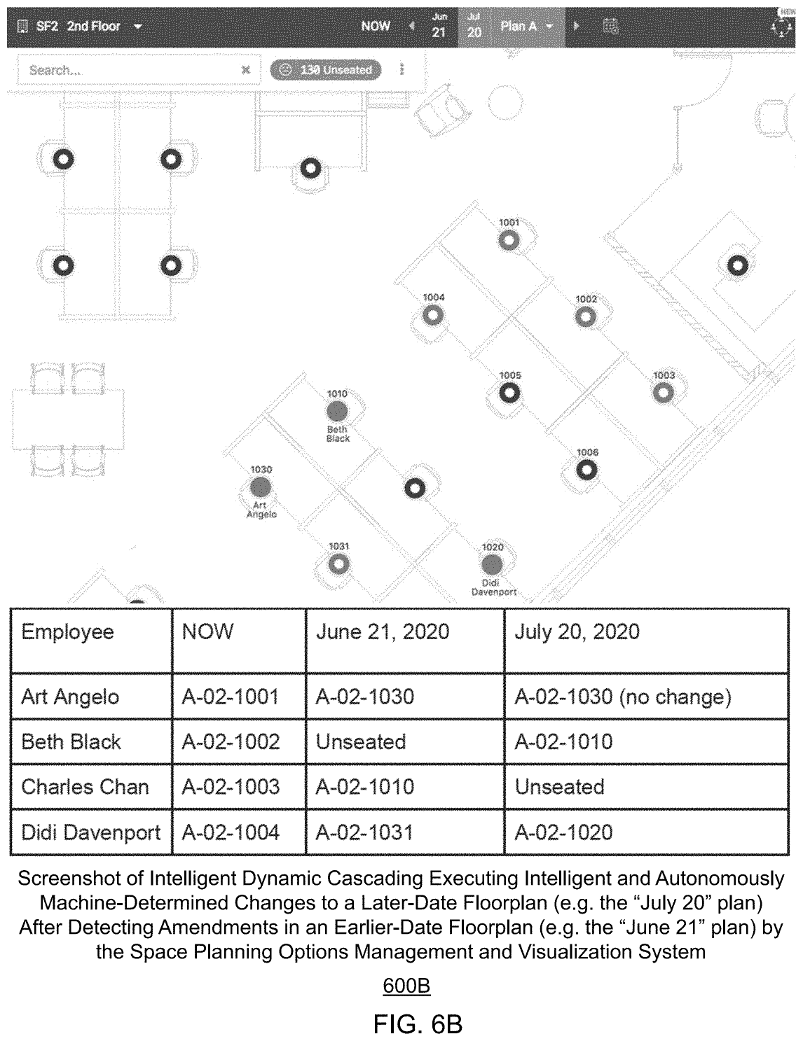

FIG. 6A shows a screenshot (600A) of the first potential future office floorplan (i.e. the “June 21” plan) after additional amendments are incorporated by the space planning options management and visualization system with intelligent dynamic cascading, in accordance with an embodiment of the invention. Furthermore, FIG. 6B shows a screenshot (600B) of intelligent dynamic cascading executing intelligent and autonomously machine-determined changes to a later-date floorplan (e.g. the “July 20” plan) after detecting amendments in an earlier-date floorplan (e.g. the “June 21” plan) by the space planning options management and visualization system with intelligent dynamic cascading, in accordance with an embodiment of the invention.

If Art Angelo's seat is updated in the June 21st plan to “A-02-1030,” his seat in the July 20th plan will also be adjusted automatically to “A-02-1030 (no change),” from “A-02-1002,” because his baseline location for July 10^{th} was meant to be the same/consistent with June 21^{st} in previous plans, as shown in FIG. 5 and FIGS. 6A˜6B. Therefore, the intelligent dynamic cascading can logically presume that no location changes are desired from June 21″ to July 20^{th} for Art Angelo, and a change to Art Angelo's seating position on June 21st should also be accompanied by the same “changed” seating position carrying onto the July 20^{th} plan, as shown in FIG. 5 and FIGS. 6A˜6B.

In contrast, as also shown in FIG. 5 and FIGS. 6A˜6B, if Didi Davenport's seat was updated on the June 21st plan to “A-02-1031” from “A-02-1001,” her seat for the July 20th plan would remain “A-02-1020” to be logically consistent with the previous configuration shown in FIG. 5, using the intelligent dynamic cascading by the space planning options management and visualization system. Maintaining the “A-02-1020” seating position for the July 20^{th} plan for Didi Davenport is based on the intelligent dynamic cascading determination that a previously and specifically-scheduled seat change for Didi on the July 20th plan precludes implied seating modifications to this later-date plan, even when a seating position change is made in the earlier-date plan (June 21^{st}) for Didi Davenport. The intelligent and cascaded modification or non-modification determinations by the machine are exemplified by the following table in this instance:

| Employee | NOW | Jun. 21, 2020 | Jul. 20, 2020 |
|---|---|---|---|
| Art Angelo | A-02-1001 | A-02-1030 | A-02-1030 |
| | | | (no change) |
| Beth Black | A-02-1002 | Unseated | A-02-1010 |
| Charles Chan | A-02-1003 | A-02-1010 | Unseated |
| Didi | A-02-1004 | A-02-1031 | A-02-1020 |
| Davenport | | | |

Thus, uniquely to this invention, the space planning options management and visualization system automatically reconciles the cascading interdependency of various plans according to their timing co-dependencies, contextual consistencies across multiple timeframes, and parallel implications.

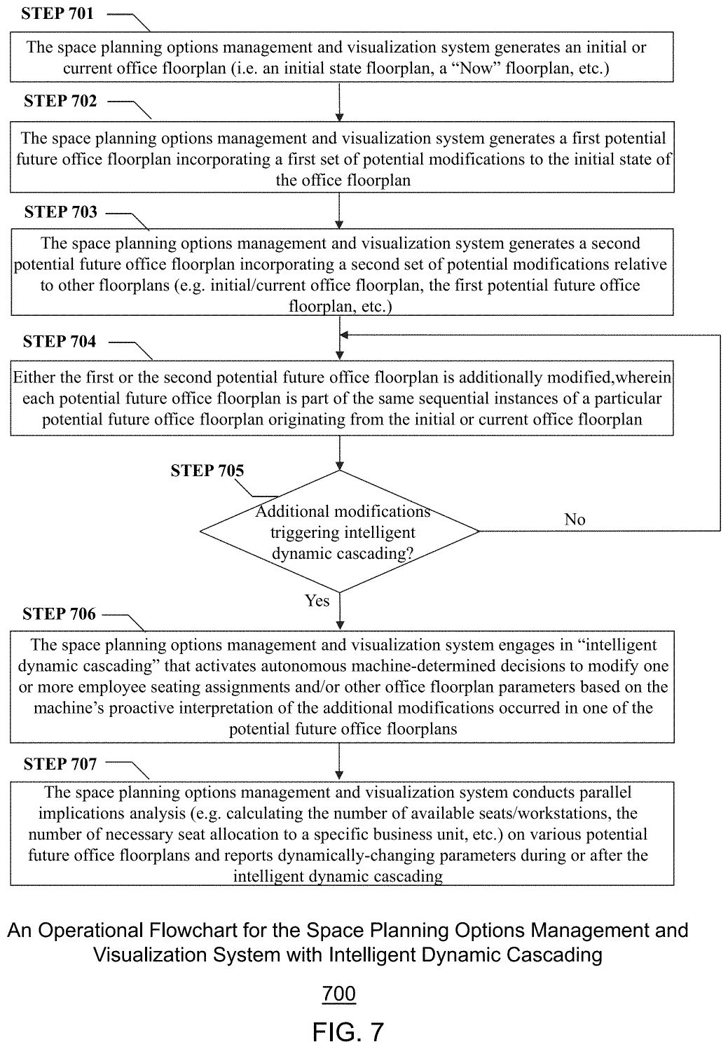

FIG. 7 shows an operational flowchart (700) for the space planning options management and visualization system with intelligent dynamic cascading, in accordance with an embodiment of the invention. As shown by STEP 701 in the operational flowchart (700), the space planning options management and visualization system first generates an initial or current office floorplan, such as an initial-state floorplan or a “NOW” floorplan, based on a space planning operator's design parameters and/or a business organization's current space utilization status in a particular office space. Then, the space planning options management and visualization system generates a first potential future office floorplan incorporating a first set of potential modifications to the initial state of the office floorplan, as shown in STEP 702.

Subsequently, the space planning options management and visualization system also generates a second potential future office floorplan that incorporates a second set of potential modifications relative to other floorplans. (e.g. the initial or current office floorplan, the first potential future office floorplan, etc.), as shown in STEP 703. Then, as shown in STEP 704, either the first or the second potential future office floorplan is additionally modified, wherein each potential future office floorplan is part of the same sequential instances of a particular potential future office floorplan originating from the initial or current office floorplan.

Continuing with the operational flowchart (700) shown in FIG. 7, if the additional modifications from STEP 704 do not cause office space design parameter timing co-dependencies, then the space planning options management and visualization system simply loops back to STEP 704 to enable the system to allow subsequent modifications to either of the potential future office floorplans, as shown in STEP 705. Otherwise, as also shown in STEP 705, if the system detects that the additional modifications from STEP 704 cause office space design parameter timing co-dependencies that may benefit from machine-based optimizations in seating assignments, team/group clustering, or other space planning decisions, then the space planning options management and visualization system engages in “intelligent dynamic cascading” that activates autonomous machine-determined decisions based on the machine's proactive interpretation of the additional modifications previously occurred in one of the potential future office floorplans, as shown in STEP 706.

Lastly, as shown in STEP 707 in the operational flowchart (700), the space planning options management and visualization system may also conduct parallel implications analysis (e.g. calculating the number of available seats or workstations, the number of necessary seat allocation to a specific business unit, etc.) on various potential future office floorplans and reports dynamically-changing parameters during or after the intelligent dynamic cascading process.

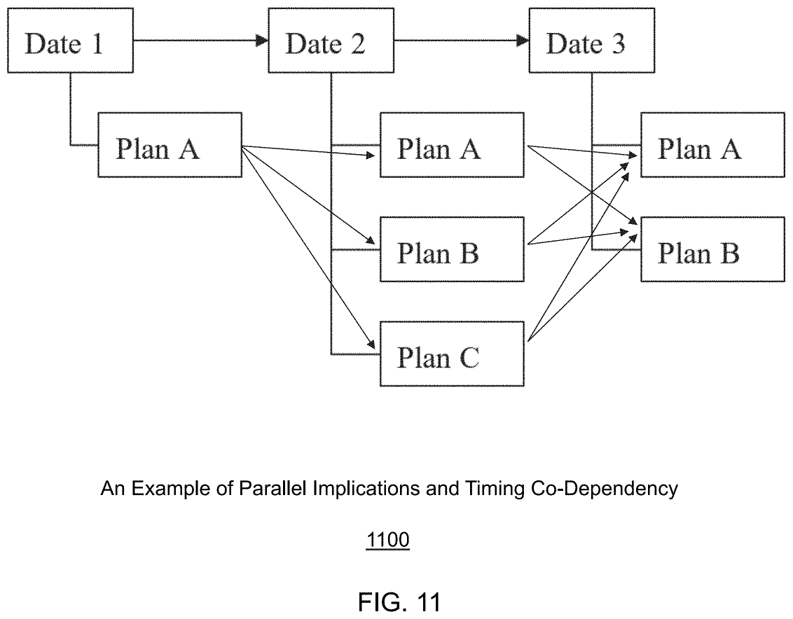

FIG. 11 shows an example (1100) of parallel implications and timing co-dependency taken account into the machine-determined intelligent dynamic cascading in various office floorplans, in accordance with an embodiment of the invention. In this example (1100), the parallel implication analysis conducted by the space planning options management and visualization system involves machine-determined autonomous analysis of potential future floorplans (e.g. Plan A˜C) in various timeframes (e.g. Date 1˜3) without a human operator intervention, which in turn automatically updates time co-dependent potential future office floorplans, when one office floorplan is changed. For example, the machine-determined parallel implications analysis may identify the number of seats that remain free and the number of seats to be allocated to a specific business unit in a given floor or building. Then, the space planning options management and visualization system may intelligently modify time co-dependent potential future plans in cascading depths (e.g. three plan-depths in “Date 2,” two plan-depths in “Date 3,” other multiple depths in future timeline floorplans the example (1100)) to make various floorplans in various timeframes and cascading depths logically congruent with an initial change in one particular floorplan. Moreover, in the preferred embodiment of the invention, the parallel implication analysis may also prioritize reducing number of employee relocation disruptions and/or costs associated with employee relocations before assigning and allocating particular employees and resources to future office floorplan pathways, depending on system user priorities and preferences in autonomous machine decision-making.

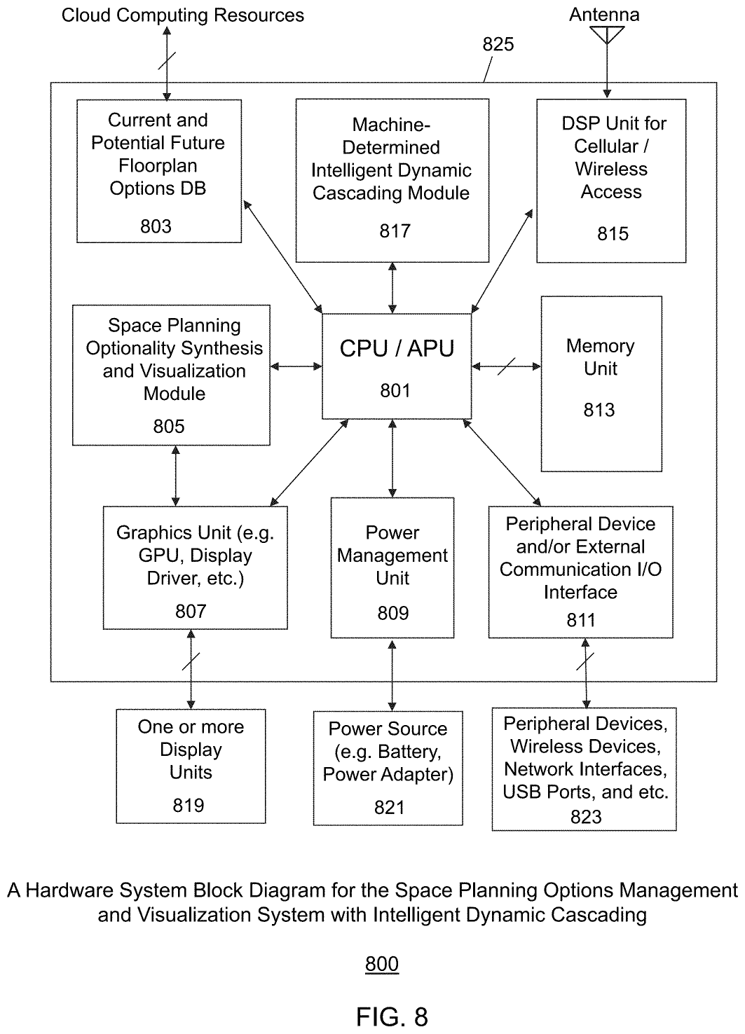

FIG. 8 shows an embodiment (800) of a hardware system block diagram (825) for the space planning options management and visualization system with intelligent dynamic cascading, in accordance with an embodiment of the invention. The space planning options management and visualization system with intelligent dynamic cascading may be implemented inside one or more stationary or portable electronic devices, such as a computer server, a desktop computer, a notebook computer, a tablet computer, a smart phone, a wearable device, another electronic device, or a combination thereof, wherein the one or more stationary or portable electronic devices are configured to incorporate and execute specialized modules (e.g. 803, 805, 817) for intelligent dynamic cascading. Such specialized modules may be implemented as embedded software in a non-volatile memory unit, as application-level software stored in a digital storage device, machine-level codes hard-coded into semiconductor chips, or a combination thereof as part of the space planning options management and visualization system with intelligent dynamic cascading.

As illustrated in FIG. 8, the hardware system block diagram (825) for the space planning options management and visualization system with intelligent dynamic cascading incorporates a current and potential future floorplan options database (803), a space planning optionality synthesis and visualization module (805), and a machine-determined intelligent dynamic cascading module (817), which may be operatively connected to each other across multiple devices or within one device as part of the system. In one embodiment of the invention, the current and potential future floorplan options database (803), the space planning optionality synthesis and visualization module (805), and the machine-determined intelligent dynamic cascading module (817) may be connected indirectly through data communication interfaces and a CPU/APU (801). In another embodiment of the invention, at least some of the modules may be connected to each other directly or integrated together for system speed and cost efficiencies.

In a preferred embodiment of the invention, at least a portion of instruction sets and data from the space planning optionality synthesis and visualization module (805) and the machine-determined intelligent dynamic cascading module (817) can be loaded onto the CPU/APU (801) and a memory unit (813) to provide the machine-determined intelligent dynamic cascading functionality to the space planning options management and visualization system.

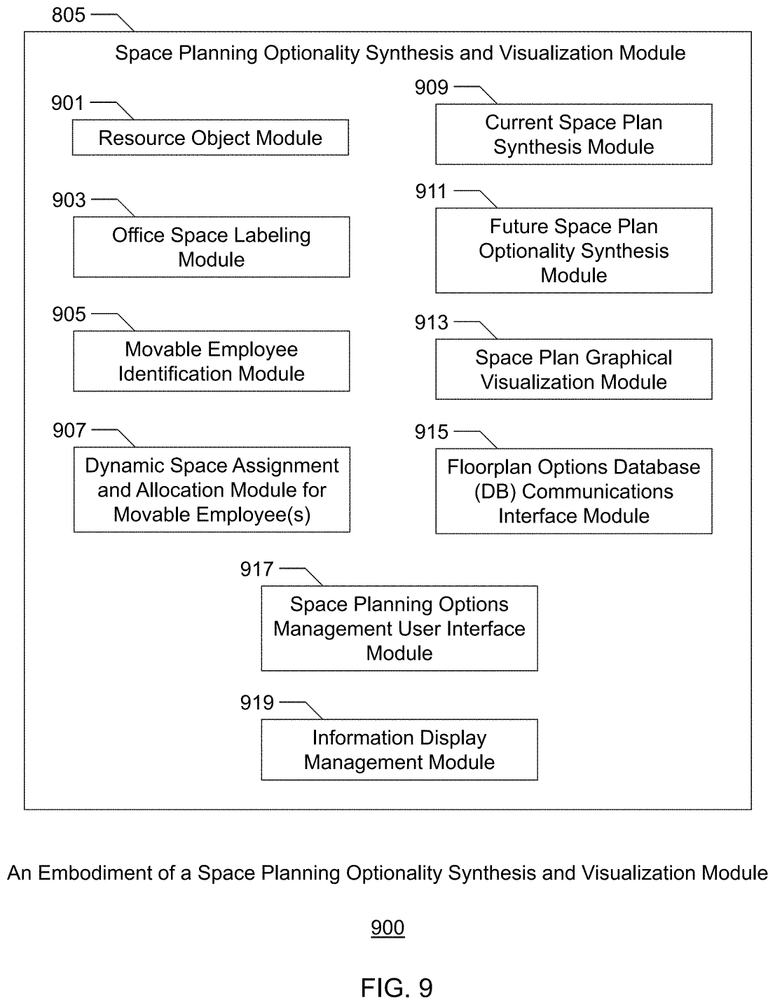

In the preferred embodiment of the invention, the space planning optionality synthesis and visualization module (805) is configured to generate a multiple number of potential office floorplans for future timeframes, wherein each potential office floorplan represents a potential future pathway for assigning specific employees and office resources to designated locations in that particular instance of the office floorplan. Multiple potential future pathways in multiple instances of the potential office floorplan can be created from the space planning optionality synthesis and visualization module (805) to allow a system operator and an office planning manger to simulate and plan for multiple potential future pathways for office resource and employee assignments in a given office space. As exemplified by an exemplary embodiment (900) in FIG. 9, the space planning optionality synthesis and visualization module (805) may be implemented with various sub-modules (e.g. 901, 903, 905, 907, 909, 911, 913, 915, 917, 919) that are illustrated and described in association with FIG. 9.

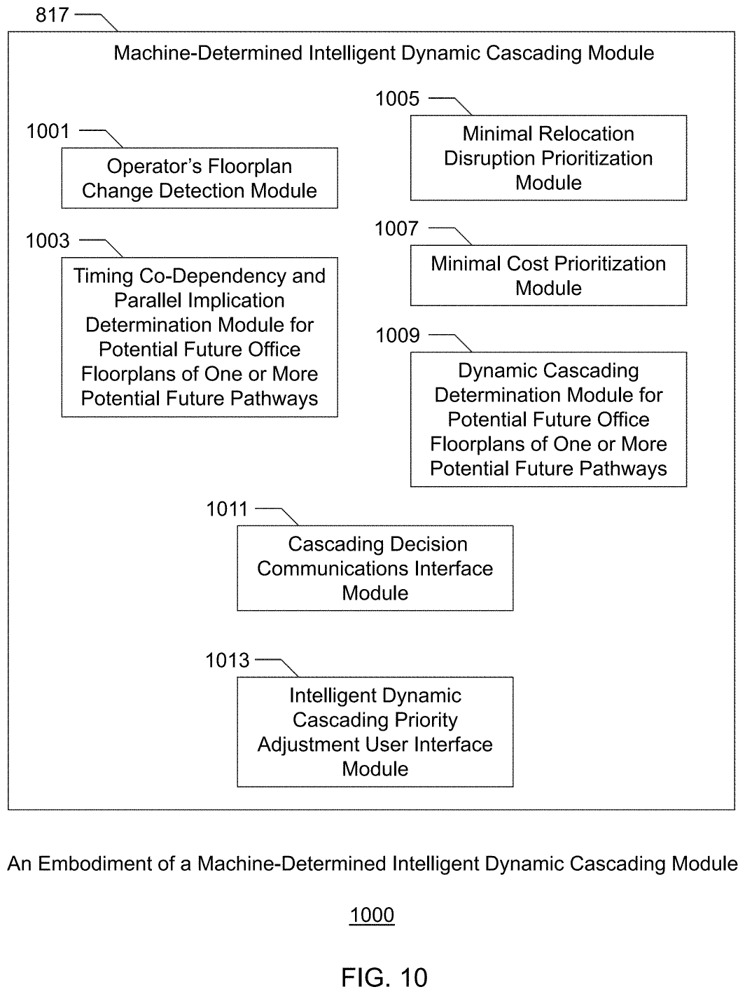

Furthermore, the current and potential future floorplan options database (803) stores various potential office floorplans for future timeframes as well as the current office floorplan synthesized from the space planning optionality synthesis and visualization module, wherein each office floorplan is categorized by office space identifiers, current and future timeframe markers, or other distinguishing markers associated with office spaces and their related resources. When a change is made to seat or resource assignments to a particular floorplan in a particular timeframe (i.e. in the current timeframe or in a hypothetical future timeframe), the machine-determined intelligent dynamic cascading module (817) is capable of executing time-codependency parallel implications analysis and “cascade” additional derivative changes in one or more depths of future timeframe office floorplans in various future pathways, as previously illustrated and described in association with FIGS. 4˜7 and FIG. 11. As exemplified by an exemplary embodiment (1000) in FIG. 10, the machine-determined intelligent dynamic cascading module (817) may be implemented with various sub-modules (e.g. 1001, 1003, 1005, 1007, 1009, 1011, 1013) that are illustrated and described in association with FIG. 10.

Moreover, in the preferred embodiment of the invention, the machine-determined intelligent dynamic cascading module (817) is also capable of autonomous machine modifications of various depths of future timeframe office floorplans in various future pathways to present operational efficiency improvements of office space assignment plans in a computer simulation and visualization environment provided by the space planning options management and visualization system. For example, the parallel implication analysis performed by the machine-determined intelligent dynamic cascading module (817) may be empowered to prioritize reducing instances of employee relocation disruptions and/or costs associated with employee relocations before assigning and allocating particular employees and resources to future office floorplan pathways via autonomous machine decisions, depending on system user priorities and preferences desired and/or configured by the system operator.

Continuing with the embodiment of the invention as shown in FIG. 8, the hardware system block diagram (800) for the space planning options management and visualization system also incorporates a CPU or an APU (801), which is operatively connected to a memory unit (813), a graphics unit (807) (e.g. a graphics processor, a display driver, and etc.), a power management unit (809), a peripheral device and/or external communication I/O interface (811), and a digital signal processing (DSP) unit for cloud server access (815) associated with the current and potential future floorplan options database (803). These logical units may be placed in a single device in one embodiment of the invention, or across multiple devices in another embodiment of the invention.

In the preferred embodiment of the invention, the CPU/APU (801) is configured to control each logical unit operatively (i.e. directly or indirectly) connected to the CPU/APU (801). The memory unit (813) typically comprises volatile memory banks based on DRAM's. In some embodiments of the invention, the memory unit (813) may use non-volatile memory technologies such as SRAM's and/or Flash memory. The memory unit (813) is capable of storing programs and applications which can be executed by the CPU/APU (801), the graphics unit (807), or another logical unit operatively connected to the memory unit (813).

In particular, in the preferred embodiment of the invention, instructions, datasets, and codes originating from the space planning optionality synthesis and visualization module (805) and the machine-determined intelligent dynamic cascading module (817) can be executed on the CPU/APU (801), the graphics unit (807), and the memory unit (813) of the space planning options management and visualization system to create a plurality of potential future office floorplans in multiple future pathways, generate computer graphics-based office floorplan visualizations and related system operator user interfaces, and execute autonomous machine determinations of time co-dependent derivative changes to various future office floorplans in cascading depths over various timeframes, based on an initial change in one particular floorplan in one particular timeframe.

In addition, as shown in FIG. 8, the digital signal processing (DSP) unit for cloud server access (815) is operatively connected to a radio frequency (RF) antenna. The DSP unit for cloud server access (815) is generally configured to receive and transmit digitized data packets wirelessly for the space planning options management and visualization system. Furthermore, the power management unit (809) is operatively connected to a power supply unit and a power source (e.g. battery, power adapter) (821), and the power management unit (809) generally controls power supplied to at least a portion of the space planning options management and visualization system and its logical units. Moreover, the peripheral device and/or external communication I/O interface (811) as shown in FIG. 8 can be operatively connected to one or more peripheral devices, wireless devices, USB ports, and other external data communication media (823).

Continuing with the embodiment of the invention as shown in FIG. 8, in the preferred embodiment of the invention, the graphics unit (807) in the hardware system block diagram example (800) for the space planning options management and visualization system comprises a graphics processor, a display driver, a dedicated graphics memory unit, and/or another graphics-related logical component. In general, the graphics unit (807) is able to process and communicate graphics-related data with the CPU/APU (801), the display driver, and/or the dedicated graphics memory unit. The graphics unit (807) is also operatively connected to one or more display units (819).

FIG. 9 shows an embodiment (900) of the space planning optionality synthesis and visualization module (805) as a preferred example of its internal logical block structure. In this embodiment (900), the space planning optionality synthesis and visualization module (805) comprises a resource object module (901), an office space labeling module (903), a movable employee identification module (905), and a dynamic space assignment and allocation module (907) for movable employees. In addition, the space planning optionality synthesis and visualization module (805) also incorporates a current space plan synthesis module (909), a future space plan optionality synthesis module (911), a space plan graphical visualization module (913), and a floorplan options database (DB) communications interface module (915).

In context of this embodiment (900) of the invention, the resource object module (901) tracks, updates, and/or stores a list of furniture equipment, office supplies, electronic equipment, and other office-related items that are utilizable by an organization for one or more office spaces. Preferably, the resource object module (901) also tracks, updates, and/or stores the current availability or the usage of such office-related items in real time, which in turn enhances accuracy and utility of potential future office floorplans by enabling the system to allocate and reassign such resource objects (i.e. furniture equipment, office supplies, electronic equipment, and other office-related items) in real-time, even in simulated future office floorplans within multiple future pathways for office space planning.

Furthermore, the office space labeling module (903) in the space planning optionality synthesis and visualization module (805) is configured to generate area-specific or sector-specific labels within an instance of a computerized office floorplan. For example, as shown in FIGS. 1˜6B, a cubicle space within a particular office floorplan may be labeled as “A-02-1001,” “A-02-1001,” “A-02-1030,” etc. Such area-specific or sector-specific office space labels enable the space planning optionality synthesis and visualization module (805) to provide a standardized point of spatial references across various computerized office floorplans representing the same physical space, regardless of office space plan timeframes or potential future pathways for each hypothetical office floorplan.

Moreover, the movable employee identification module (905) in the space planning optionality synthesis and visualization module (805) is configured to track, update, and/or store a list of employees or workers of the organization who may be subject to seating reassignments or office space relocations. For example, “Employee A” may be marked as “unseated” and/or “not subject to future relocation” in potential future office floorplans after Jun. 20, 2020, because the movable employee identification module (905) connected to the dynamic space assignment and allocation module (907) has already flagged “Employee A” as resigning from the organization prior to Jun. 20, 2020. In another example, “Employee B” may be marked as “unmovable” the movable employee identification module (905) for potential future office floorplans involving dates after Jan. 1, 2020, if the manger of “Employee B” has requested avoidance of seating reassignments or relocation for this individual starting on Jan. 1, 2020.

The tracking of the list of employees or workers may be further categorized by a specific department, a project team, or another organizational classification within the total set of employees or workers for the organization. By providing a real-time tracking and identification of employees or workers who are either subject to or not subject to seating reassignments or office space relocations, the movable employee identification module (905) enables efficient and realistic office space planning options synthesis and visualizations in an immersive computer graphics environment, as shown previously in FIGS. 1˜6B.

Continuing with the embodiment (900) of the invention as shown in FIG. 9, the space planning optionality synthesis and visualization module (805) also includes the dynamic space assignment and allocation module (907), which is configured to link a particular location in an office floorplan of a particular timeframe (i.e. current or future) with a listed employee from the movable employee identification module (905), and in some cases, with one or more office resource objects listed as available from the resource object module (901). Preferably, the particular location in the office floorplan has an area label designated from the office space labeling module (903), and the dynamic space assignment and allocation module (907) is able to allocate and assign various employees and resource objects dynamically to the particular location in the office floorplan either through a system operator's manual adjustments or through autonomous machine determinations for intelligent dynamic cascading from the space planning options management and visualization system.

Furthermore, the current space plan synthesis module (909) in the space planning optionality synthesis and visualization module (805) is able to create a computer graphics-based office space floorplan in the present timeframe, which is a present-day configuration of a particular office space with present-day employee desk, cubicle, office, and office resource object assignments. In the preferred embodiment of the invention, this present-day configuration of the computer graphics-based office space floorplan is not a hypothetical simulation of office space setup, but rather a real-life symbolization of the present office space configuration. In another embodiment of the invention, the present-day configuration of the computer graphics-based office space floorplan may also be accompanied by multiple instances of hypothetical present-day office space configurations through space planning optionality synthesis and visualizations. The current space plan synthesis module (909) is configured to request and receive various real-time information from the resource object module (901), the office space labeling module (903), the movable employee identification module (905), and the dynamic space assignment and allocation module (907) to synthesize an integrated present-day office space floorplan with space labels, designated employees in specific locations, and/or office resource objects allocated to specific locations. Preferably, the actual computer graphics generation for visualization of the synthesized present-day office space floorplan is conducted by the space plan graphical visualization module (913), as shown in FIG. 9.

Similarly, the future space plan optionality synthesis module (911) in the space planning optionality synthesis and visualization module (805) is configured to create a computer graphics-based office space floorplan for a future timeframe in a potential future pathway, which is a hypothetical and simulated future configuration of a particular office space with employee desk, cubicle, office, and office resource object assignments. In the preferred embodiment of the invention, this hypothetical and simulated future configuration of the computer graphics-based office space floorplan is an imaginary symbolization, which may be one of many instances of potential future pathways. For example, the future space plan optionality synthesis module (911) may create and simulate five different instances of the office space floorplan for the same future timeframe (e.g. 2 years from today) with different arrangements for employee desk, cubicle, office, and office resource object assignments through space planning optionality synthesis and visualizations.

In the preferred embodiment of the invention, the future space plan optionality synthesis module (911) is configured to request and receive various real-time information from the resource object module (901), the office space labeling module (903), the movable employee identification module (905), and the dynamic space assignment and allocation module (907) to synthesize an integrated future office space floorplan with space labels, designated employees in specific locations, and/or office resource objects allocated to specific locations. Preferably, the actual computer graphics generation for visualization of the synthesized future office space floorplan is conducted by the space plan graphical visualization module (913), as shown in FIG. 9.

Moreover, in the embodiment (900) of the invention as shown in FIG. 9, the space planning optionality synthesis and visualization module (805) also includes the floorplan options database (DB) communications interface module (915), which enables the space planning optionality synthesis and visualization module (805) to retrieve various floorplans stored in the current and potential future floorplan options database (803) for further processing, or to upload newly-synthesized or updated floorplans to the current and potential future floorplan options database (803). Preferably, the floorplan options database (DB) communications interface module (915) is configured to receive digitized data from or transmit digitized data to the current and potential future floorplan options database (803) through wired connections or wireless data communication protocols.

In the preferred embodiment of the invention, the space planning optionality synthesis and visualization module (805) may further include a space planning options management user interface module (917) and an information display management module (919), as shown in FIG. 9. The space planning options management user interface module (917) allows the system operator to adjust various system operation settings, such as particular data parameters (e.g. resource object allocations, space configuration adjustments, location labels, employee seating assignments, etc.) associated with specific floorplans and floorplan creations, modifications, or deletions. Furthermore, the information display management module (919) enables the space planning optionality synthesis and visualization module (805) to organize and display office space plan visualizations on a computerized display interface, while also empowering the system operator to specify or adjust office floorplan visualization viewing preferences.

FIG. 10 shows an embodiment (1000) of the machine-determined intelligent dynamic cascading module (817) as a preferred example of its internal logical block structure. In this embodiment (1000), the machine-determined intelligent dynamic cascading module (817) comprises an operator's floorplan change detection module (1001), a timing co-dependency and parallel implication determination module (1003) for potential future office floorplans of one or more potential future pathways, a minimal relocation disruption prioritization module (1005), a minimal cost prioritization module (1007), and a dynamic cascading determination module (1009) for potential future office floorplans of one or more potential future pathways, as shown in FIG. 10.

In the preferred embodiment of the invention, the operator's floorplan change detection module (1001) is able to detect a change initiated by the system operator to an office floorplan of a particular timeframe. Then, the timing co-dependency and parallel implication determination module (1003) evaluates timing co-dependency and parallel implications in all other instances of the office floorplan in one or more timeframes, based on a recent change made to the office floorplan of the particular timeframe, as previously illustrated as examples in FIGS. 1˜6B and FIG. 11. In this example, the timing co-dependency and parallel implication determination module (1003) then autonomously determines (i.e. without a system operator intervention) which instances of potential future floorplans necessitate “cascaded” changes to maintain seating assignments and resource object allocations logically consistent within a universe of already-created potential future floorplans stored in the current and potential future floorplan options database (803).

The floorplans identified and flagged by the timing co-dependency and parallel implication module (1003) to require “cascaded” modifications are then further processed by the dynamic cascading determination module (1009) for specific modifications (e.g. seating reassignments, resource object reallocations, rearrangements of seating clusters by departments or floor levels, etc.) within each instance of the floorplan. Preferably, these “cascaded” modifications are made autonomously and intelligently by the machine in pertinent floorplans identified by the timing co-dependency and parallel implication module (1003) and the dynamic cascading determination module (1009), as previously shown in the example illustrated in FIGS. 4˜6B and FIG. 11, even without a system operator's direct manipulation of floorplans through an electronic user interface.

Furthermore, if the intelligent dynamic cascading is configured to include machine-determined prioritization parameters such as minimal relocation disruptions, minimal cost incurrence, or another organizational efficiency-improving parameter, then the dynamic cascading determination module (1009) for potential future office floorplans of one or more potential future pathways further modifies one or more instances of future office floorplans to optimize seating assignments and resource object allocations, in accordance with organizational efficiency-improving parameters set by the system. In context of the embodiment (1000) of the invention as shown in FIG. 10, the minimal cost prioritization module (1007) identifies and recommends specific changes in one or more instances of potential future floorplans to minimize costs associated with employee seating and resource object reallocations in the office space. For example, if one possible dynamic cascading approach that meets all criteria of timing co-dependency and parallel implication determination likely incurs $25,000 in reseating and reallocation costs, while another qualified dynamic cascading approach also meets all criteria but likely incurs only $6,000 in overall cost estimates, the minimal cost prioritization module (1007) may recommend the latter approach to minimize relocation costs to the organization These recommended changes may then be executed by the dynamic cascading determination module (1009) to electronically modify pertinent instances of potential future floorplans.

Similarly, in the preferred embodiment of the invention, the minimal relocation disruption prioritization module (1005) identifies and recommends specific changes in one or more instances of potential future floorplans to minimize relocation disruptions associated with employee seating and resource object reallocations in the office space. For example, if one possible dynamic cascading approach that meets all criteria of timing co-dependency and parallel implication determination involves relocating and reseating four employees, while another qualified dynamic cascading approach also meets all criteria but only involves reseating one employee, the minimal relocation disruption prioritization module (1005) may recommend the latter approach, instead of the former approach, to minimize relocation disruptions to the organization. These recommended changes may then be executed by the dynamic cascading determination module (1009) to electronically modify pertinent instances of potential future floorplans

Continuing with the embodiment (1000) of the invention as shown in FIG. 10, the machine-determined intelligent dynamic cascading module (817) may further include a cascading decision communication interface module (1011) and an intelligent dynamic cascading priority adjustment user interface module (1013), as shown in FIG. 10. The cascading decision communication interface module (1011) enables the machine-determined intelligent dynamic cascading module (817) to transmit machine-determined cascading decisions to the space planning optionality synthesis and visualization module (805) and to the current and potential future floorplan options database (803).

Typically, the machine determined cascading decisions are floorplan modification instructions that electronically modify a portion of one or more future office floorplans, which are determined by the dynamic cascading determination module (1009) to be timing co-dependent to an earlier change made to another floorplan in the space planning options management and visualization system. Preferably, the cascading decision communication interface module (1011) is configured to receive digitized data from or transmit digitized instructions and data to the space planning optionality synthesis and visualization module (805) and the current and potential future floorplan options database (803) through wired connections or wireless data communication protocols.

Moreover, in the preferred embodiment of the invention, the intelligent dynamic cascading priority adjustment user interface module (1013) in the machine-determined intelligent dynamic cascading module (817) allows the system operator to adjust dynamic cascading priority settings for autonomous machine determinations of multi-depth future office floorplan modifications, such as placing greater emphasis on minimizing relocation, reseating, or reassignment disruptions vs. minimizing costs, or vice versa, in executing machine-determined cascading decisions.

While the invention has been described with respect to a limited number of embodiments, those skilled in the art, having benefit of this disclosure, will appreciate that other embodiments, which do not depart from the scope of the invention, can also be devised and readily understood by one of ordinary skill in the art. Accordingly, the scope of the invention should be limited only by claims presented herein.

What is claimed is:

1. A method for operating a space planning options management and visualization system with intelligent dynamic cascading for efficient office space planning simulations, the method comprising the steps of:
generating a current-state office floorplan as a first set of computer-rendered graphics from a space planning optionality synthesis and visualization module connected to a CPU and a memory unit in the space planning options management and visualization system, wherein the current-state office floorplan includes at least one of employee seating assignments and office resource object allocation configurations;
generating a first potential future office floorplan as a second set of computer-rendered graphics from the space planning optionality synthesis and visualization module connected to the CPU and the memory unit in the space planning options management and visualization system, wherein the first potential future office floorplan incorporates a first modification in the employee seating assignments or in the office resource object allocations relative to the current-state office floorplan;
generating a second potential future office floorplan as a third set of computer-rendered graphics from the space planning optionality synthesis and visualization module connected to the CPU and the memory unit in the space planning options management and visualization system, wherein the second potential future office floorplan incorporates a second modification in the employee seating assignments or in the office resource object allocations relative to at least one of the current-state office floorplan and the first potential future office floorplan;
executing a third modification to either the first potential future office floorplan or the second potential future office floorplan as a fourth set of computer-rendered graphics from the space planning optionality synthesis and visualization module connected to the CPU and the memory unit in the space planning options management and visualization system, wherein the first potential future office floorplan and the second potential future office floorplan are part of same time-sequential instances originating from the current-state office floorplan; and
if the third modification triggers an intelligent dynamic cascading process due to timing co-dependencies between the first potential future office floorplan and the second potential future office floorplan:
executing the intelligent dynamic cascading process from a machine-determined intelligent dynamic cascading module connected to the CPU and the memory unit in the space planning options management and visualization system, which in turn activates autonomous machine-determined decisions to automatically modify, without a human operator intervention, at least one of the employee seating assignments and the office resource object allocations to keep both the first potential office floorplan and the second potential future office floorplan logically consistent across different timeframes; and
graphically rendering a newly-updated potential future office floorplan that incorporated machine-determined modifications to the employee seating assignments or to the office resource object allocations after executing the intelligent dynamic cascading process.

2. The method of claim 1, further comprising a step of conducting a parallel implications analysis from the machine-determined intelligent dynamic cascading module to calculate available seats, resource object allocations to a particular department, or other dynamically-changing parameters in the newly-updated potential future office floorplan after executing the intelligent dynamic cascading process from the space planning options management and visualization system.

3. The method of claim 1, wherein the space planning optionality synthesis and visualization module and the machine-determined intelligent dynamic cascading module are operatively connected to a current and potential future floorplan options database, which stores and categorizes a plurality of current and future office floorplans that represent multiple future pathways for office space planning.

4. The method of claim 1, wherein the space planning options management and visualization system further includes a graphics unit, a power management unit, and a peripheral device and external communication interface.

5. The method of claim 1, wherein the space planning optionality synthesis and visualization module in the space planning options management and visualization system incorporates a resource object module, an office space labeling module, a movable employee identification module, a dynamic space assignment and allocation module for movable employees, a current space plan synthesis module, a future space plan optionality synthesis module, a space plan graphical visualization module, and a floorplan options database communication interface module.

6. The method of claim 5, wherein the space planning optionality synthesis and visualization module in the space planning options management and visualization system additionally incorporates a space planning options management user interface module and an information display management module.

7. The method of claim 1, wherein the machine-determined intelligent dynamic cascading module incorporates an operator's floorplan change detection module, a timing co-dependency and parallel implication determination module, and a dynamic cascading determination module for potential future office floorplans of one or more potential future pathways.

8. The method of claim 7, wherein the machine-determined intelligent dynamic cascading module additionally incorporates a minimal relocation disruption prioritization module, a minimal cost prioritization module, a cascading decision communications interface module, and an intelligent dynamic cascading priority adjustment user interface module.
